(19) United States
(12) Patent Application Publication
(10) Pub. No.: US 2012/0125624 A1
(43) Pub. Date: May 24, 2012

(54) Ultra-pumps systems

(76) Inventor: Richard J. Dyer, Bakersfield, CA (US)

(21) Appl. No.: 13/373,163

(22) Filed: Nov. 7, 2011

Related U.S. Application Data
(60) Provisional application No. 61/458,200, filed on Nov. 20, 2010.

(51) Int. Cl. E21B 43/00; F16K 21/04

(52) U.S. Cl. 166/369; 137/565.15; 166/105.3

(57) ABSTRACT

This invention provides a positive displacement gas operated pump and pumping system for pumping fluids such as hydrocarbons/oil as well as solids that may be suspended in such fluids. More specifically, the invention relates to a method and apparatus for the recovery of hydrocarbons/oil from underground water tables and/or where water flooding has previously been used to further extract hydrocarbons/oil from underground areas, but economics prevent further recovery from such areas and/or wells.

### RELATED PATENT APPLICATIONS

This present pending utility patent application is derived from pending provisional patent application Ser. No. 61/458,200 filed on Nov. 20, 2010 and is the priority date for this pending utility patent application.

### FIELD OF THE INVENTION

This invention relates to an ultra pump system for reducing costs and increasing production in pumping fluids, particularly from underground locations, and for the provision of a environmentally friendly operation thereof. For example, this invention provides a positive displacement gas operated pump and pumping system for pumping fluids such as hydrocarbons/oil as well as solids that may be suspended in such fluids. More specifically, the invention relates to a method and apparatus for the recovery of hydrocarbons/oil from underground water tables and/or where water flooding has previously been used to further extract hydrocarbons/oil from underground areas, but economics prevent further recovery from such areas and/or wells.

### BACKGROUND OF THE INVENTION

In one aspect of the present invention, there is provided an ultra pump system for the highly effective method of recovery of underground materials such as hydrocarbons like oil from wells that are no longer producing oil and that have been shut-in for economical reasons. Another aspect of the present invention is directed to methods and apparatus for recovery of hydrocarbons from underground water tables, for both water decontamination purposes and providing a commercially usable petroleum origin hydrocarbon byproduct as a result of the decontamination of the water table, and more particularly, to recovery of petroleum origin hydrocarbon liquids that have collected underground at the sites of refineries and other oil and gas storage and/or dispersement and/or handling, piping or the like, facilities, where, due to spillage and the like, the petroleum origin hydrocarbons in liquid form have gone underground in quantities sufficient to warrant purging of the ground water table of same and have as a byproduct of the removal operation, adequate quantities of the hydrocarbons for processing as needed to provide a commercially appealing end product.

It is well known that at refineries and other facilities where petroleum products are processed and handled, substantial quantities of the petroleum origin liquids involved (hereinafter sometimes referred to for convenience of reference and description as petroleum origin hydrocarbons or “hydrocarbons”), are lost into the ground due to spillage and the like. Over a period of time the hydrocarbons involved tend to seep down into the ground to the ground water table level, and collect there. As liquid hydrocarbons have a specific gravity that is less than that of water, and they are, generally speaking, immiscible with water, they form their own liquid table level on top of the ground water table. While there may be some admixing of the two discrete types of liquids as the ground water table rises and falls over a period of time, the liquid hydrocarbons that are underground tend to remain a separate and distinct liquid strata (sometimes referred to herein as oil pad) on top of the ground water table having water table characteristics that are similar to those of the ground water table.

In the past, such hydrocarbons have been recovered from wells formed at these locations and extending well down into the water table, by pumping the ground water from the well and piping it to a ground level point of disposal that is remote from the well, to create a so-called cone of depression in the ground water table adjacent the well, with the result that the liquid hydrocarbons there located tend to flow under gravity toward the center of the cone of depression and collects there. The ground water removed to form the cone of depression, known as draw down water, is conveyed to a disposal or storage site sufficiently remote from the well to avoid the water flowing right back into the cone of depression that has been created in the ground water table to in effect serve as a collection basin for the hydrocarbons to be recovered.

Apparatus employed for the purpose of recovery of underground hydrocarbons at sites of the type indicated, and/or at wells that have been treated by water flooding, and/or at wells that have been shut-in for economic reasons, have generally involved mechanical pumping arrangements of the centrifugal and other common mechanical pump types that are suspended in the well in the hydrocarbons and water and operated to pump these liquids and/or hydrocarbons from the well to ground level. These prior art approaches have involved a number of problems that in the past have made it difficult to recover these hydrocarbons, in quantities adequate in quantity and quality to warrant commercial exploitation of same, and consequently limited incentives to try to recover small quantities of the hydrocarbons. For example, “rocker arms” rotating devices are highly expensive and thus are not economically feasible to install in such locations wherein small quantities of oil are located; the present invention, however, provides an apparatus, ultra pumping system, or device which costs about 3-5 percent of the cost of a rocker arm apparatus.

For instance, one currently practiced approach is to deliver the recovered hydrocarbon liquids through a filter that tends to plug up all too readily. Further, mechanical pumps that are employed are ordinarily electrically driven, and since hydrocarbons are highly inflammable, fire danger is an ever present problem. Also, as the hydrocarbons involved are removed, the pumping speeds have to be changed to be commensurate with the hydrocarbons remaining to be recovered, which requires expensive variable speed drives for the pump equipment involved.

As to the ground water removed to form the indicated cone of depression, it is important that the draw down involved be as little as possible since once the ground is contaminated with hydrocarbons, it will retain some of the hydrocarbons even after the bulk of same have been removed. Thus, where centrifugal and other mechanical types of water pump equipment are involved for draw down purposes, some type of level sensing device and expensive variable speed controls would be required in order for the equipment to operate properly, and as draw down pumps are usually suspended near the bottom of the well, a substantial amount of debris will be passing through the pump with resulting high pump maintenance requirements.

In view of environmental concerns regarding the production of large quantities of undesirable water and the disposal thereof, the above practices greatly inhibit the recovery of hydrocarbons/oil from underground locations, including but not limited to, wells that have been shut-in or are no longer in operation.

Pumping apparatus for the recovery of liquid hydrocarbons/oil (fluids) have been used for many years, but as the quantities of desired liquids has decreased, the use of complex and/or expensive equipment, such as rocker arms, cannot justify the continued use thereof. A problem with the existing designs is that they often require numerous component parts, including moving parts, and therefore tend to be complex, capital intensive and expensive to operate. For example, such pumping equipment/products often use stationary inlets in conjunction with hydrophobic screens, floating inlets attached to coils, or more complex inlet structures used in conjunction with sensors and pneumatic cylinders. Stationary inlets may be mispositioned out of the product when the water level drops, or they can be completely submerged under the water if the level rises to an unacceptably high degree. Hydrophobic screens can be easily fouled and plugged, and floating inlets can hang up for various reasons. Coils may also be plugged by discharged hydrocarbons and other thicker fluids.

Prior art that exemplifies the significant issues and problems in the industry and the alleged attempts to solve these problems are set forth below.

U.S. Pat. No. 4,589,494 discloses a method of controlling the removal of flowable material from a well using a pump in the well which includes a housing having at least one aperture leading to an interior chamber within the housing so that flowable material from the well can enter the chamber and a pressure responsive valve for opening and closing the aperture. Gas is supplied under pressure through a conduit to the pump to close the valve to terminate entry of the flowable material into the chamber and to force the flowable material out of the pump. The flow of gas under pressure is then terminated, and gas from the conduit is vented. The venting is carried out during the time that the gas under pressure is supplied through the conduit to the pump and following the termination of the flow of gas to the pump to bleed gas under pressure from the conduit and the pump so that flowable material from the well can again enter the chamber.

U.S. Pat. No. 4,649,994 provides an installation provided for bringing into production hydrocarbon deposits with reinjection of effluents into the deposit or into the well or wells and a process for using this installation. Said installation comprises at least one sealed casing whose base communicates with the deposit; at least one sealing plug disposed in the lower part of the casing and forming a capacity; at least one duct for either injecting or removing a pressurized gas; a condensate injection pipe passing through the capacity and opening into the base of the casing beyond said plug; a production pipe passing through said capacity and possibly through said plug, this pipe communicating with the inner volume of the casing downstream of the plug, as well as with said capacity through a complex valve system.

U.S. Pat. No. 4,625,801 discloses methods and apparatus for the recovery of petroleum origin hydrocarbons from ground water tables at sites of refineries, oil and gasoline storage and distributing facilities, and the like. Pursuant to the disclosure therein, separate liquid handling devices, each in the nature of a vessel or canister and having liquid trapping and ejecting facilities that are free of mechanical pumping action, are employed for raising the ground water and liquid hydrocarbons that accumulate on the ground water table, respectively, through which the well or wells extend, and under the static pressure of the compressed air. The indicated devices are suspended in the same or adjacent wells that are located at the site, with the ground water handling device being connected to a source of compressed air and piping for carrying away the water to form a cone of depression at the site, and the hydrocarbon handling device being connected to the source of compressed air and a recovery line for separately surfacing and conveying the hydrocarbons to a point of collection and recovery. The method also provides for use of one of the vessels and associated equipment to pump both liquids from the well to the ground surface for separation of same by a conventional separator.

U.S. Pat. No. 4,684,295 discloses a pneumatic device for pumping a solid-carrying liquid or slurry, which operates intermittently and is continuously under load, comprises a tubular body in which a flap valve is mounted so that it pivots in the downstream direction on a support and cooperates with a seat to close a passage port at the entry of a pumping chamber, between the seat and the delivery port. A pipe, which allows compressed air to enter, opens into the pumping chamber. The valve is opened under the pressure of the solid-carrying liquid or slurry to be conveyed, when compressed air is not allowed to enter the chamber. The entry of air causes the valve to close and the chamber to empty. A valve which is operated by a timing device controls the filling and emptying sequences. The device is alleged to be useful for pumping dense slurries and solid-carrying liquids.

U.S. Pat. No. 4,990,061 discloses a well pumping system using a closed gas cycle to periodically unload a pumping chamber in a well. The system includes a tubing string having a down hole pumping chamber providing a check valve at the lower end. A packing assembly defines the upper end of the pumping chamber and includes a dip tube having a check valve allowing upward liquid movement through the dip tube. A conduit passes through the packing assembly. Pressurized gas is periodically pumped down the conduit to force liquid upwardly through the dip tube and tubing string. Cycling of the pressurized gas is controlled by a liquid seal control assembly at the surface. When the pumping chamber has been unloaded, the gas therein flows up the conduit and through the seal control assembly to a suction tank. The pressurized gas is thus maintained in a closed cycle.

U.S. Pat. No. 5,007,803 discloses a compressed air-actuated pump includes a venturi nozzle to create a vacuum condition within a fluid-tight pump body to pump in a liquid or slurry. When a given level of liquid is pumped in, a control circuit closes a flexible sleeve of a pneumatically actuated pinch valve positioned in an exhaust passageway of the venturi nozzle. Upon closing of the pinch valve, the exhaust stream from the venturi nozzle is diverted into the pump body to create a pressurized condition therein whereby the liquid or slurry previously accumulated therein is pumped out. The pump also includes a pair of variable flow control valves for independently adjusting the flow rates of compressed air through the venturi nozzle in the vacuum, pump-in and in the pressurized, pump-out cycles. Solid state opto-electronic liquid level sensors or appropriate pneumatic, electric or electro-pneumatic timing devices are employed to signal the opening and closing of the pinch valve. The flexible sleeve of the pinch valve, as well as all other parts in the pump, are constructed of chemically-resistant materials to permit the pumping of erosive, corrosive and abrasive liquids and slurries.

U.S. Pat. No. 5,248,243 discloses a pneumatically operated and controlled pump which is capable of maintaining its efficiency and reliability in various environments. The pump head contains a spool and sleeve valve assembly operated in response to a signal pressure. The assembly controls the cycling of the pump through a pumping phase and a pump filling phase. A timing switch on the surface controls the occurrence of the signal pressure and thus the pump cycles, at preset intervals thus eliminating any lag time between the cycles and the need for operator estimations of the cycle times. This results in a virtually closed system and self contained unit.

U.S. Pat. No. 6,220,823 discloses an air-operated, submersible pump features a simplified inlet design applicable to water pumping or fluid separation, including the recovery of viscous hydrocarbon products. The inlet area fluidly penetrates through a portion of the wall of the pump, and a flexible seal, disposed within the pump body, is supported in overlying registration therewith. A pressure-operated valve in fluid communication with the discharge port facilitates a refill mode of operation, wherein fluid surrounding the pump flows into the pump body through the inlet area, and a discharge mode of operation wherein the air inlet is pressurized, causing the seal to seat against and seal off the inlet area, and fluid which flowed into the pump body to be discharged through the discharge port. In the preferred embodiment, the inlet area comprises a plurality of apertures formed through the wall of the pump body arranged as one or more linear arrays lengthwise along the pump. When deployed to separate and recover a layer of fluid floating on water, a pump according to the invention pump further includes a water outlet and a water-outlet seal. During the refill mode of operation, water including the floating layer of fluid flows into the pump body through the inlet area, and in the discharge mode of operation, the pressurization further causes water which flowed into the pump body to be discharged through the water outlet until the outlet is sealed, after which the fluid which flowed into the pump body is discharged through the discharge port.

U.S. Pat. No. 6,224,343 discloses an air-operated pump for groundwater sampling features a corrugated bellows as opposed to the traditional bladder used for fluid collection. The preferred embodiment includes an air-supply line and a fluid-discharge line, each coupled to the pump body through a controller disposed at an appropriate above-ground location. The bellows is operable between a refill state, wherein fluid is drawn into the pump body through the fluid inlet, and a discharge state wherein fluid is forced out of the pump body through the discharge line. An apparatus disposed within the pump body governs the air received through the air-supply line to, at least, semi-automatically cycling the bellows between the refill and the discharge states. To assist in cycling, the pump may further include one or more magnets for latching the bellows in the refill or discharge state, and an electrical sensor for detecting whether or not the bellows is latched. As an alternative, the apparatus for governing the air received through the air-supply line may include a valve in the air-supply line which is mechanically coupled to the bellows. A separate exhaust line may also be provided to expel air received through the air-supply line, in which case the apparatus for governing the air received through the air-supply line also governs the air expelled through the exhaust line.

U.S. Pat. No. 6,234,761 discloses a pump having a pump chamber arranged to receive water to be pumped along with air, a delivery pipe for delivery of the water by the air to a location remote from said pump chamber, an air pipe for flow of air therein. The delivery pipe and pump chamber are in fluid communication, as are the air pipe and said pump chamber. A first air flow control to control air flow via said air pipe during first and second stages of a pumping cycle of the pump. A timer controls the operation of said first air flow control to thereby set the durations of said first and second stages of said pumping cycle. A first valve allows water to enter said pump chamber. Wherein in said first stage of the pumping cycle of the pump, the first air flow control allows air to be directed via said air pipe to said pump chamber for a time period set by said timer to cause water and air to be transferred from said pump chamber into said delivery pipe with the water/air combination for delivery via said delivery pipe to said location. In the second stage of the pumping cycle said first air flow control allows unused air to vent from said pump chamber via said air pipe for a time period set by said timer. The first valve allows water to enter said pump chamber while water and air are able to continue to travel along said delivery pipe toward said location.

U.S. Pat. No. 6,632,073 discloses an air-operated, submersible pump features a bladder-controlled inlet applicable to water pumping or fluid separation, including the recovery of viscous hydrocarbon products. The inlet area fluidly penetrates through a portion of the wall of the pump, and the bladder, disposed within the pump body, is supported in overlying registration therewith. A pressure-operated valve in fluid communication with the discharge port facilitates a refill mode of operation, wherein fluid surrounding the pump flows into the pump body through the inlet area, and a discharge mode of operation wherein the air inlet is pressurized, causing the bladder to inflate and seat against and seal off the inlet area, and fluid which flowed into the pump body to be discharged through the discharge port. In the preferred embodiment, the inlet area comprises a plurality of apertures formed through the wall of the pump body arranged as one or more linear arrays lengthwise along the pump. When deployed to separate and recover a layer of fluid floating on water, a pump according to the invention pump further includes a water outlet and a water-outlet seal. During the refill mode of operation, water including the floating layer of fluid flows into the pump body through the inlet area, and in the discharge mode of operation, the pressurization further causes water which flowed into the pump body to be discharged through the water outlet until the outlet is sealed, after which the fluid which flowed into the pump body is discharged through the discharge port.

In viewing the figures/drawings of each of the prior art patents cited above, it can readily be seen that each one involves complex equipment arrangements, numerous moving parts (subject to be worn out and/or not properly functioning) and the costs thereof are prohibitive in light of the quantities of fluids/oil to be recovered.

Consequently, it is one object of this invention to provide an improved well pump and pumping system which overcomes the above stated disadvantages, and substantially reduces costs with the significant increase of production of only the desired material such as oil.

A further object of this invention is to provide a simple, inexpensive well pumping system requiring very little maintenance and only one moving part.

Another object of this invention is to provide a pumping system for removing desired underground hydrocarbons, such as oil, with a very minimum production of undesirable water, preferably less than ten percent by weight water, generally 2-5 percent; (this is compared to the normal water production of 95 to 98 percent by weight using prior art apparatus and methods and as disclosed in the prior art cited above).

Other objects and advantages of this invention will become more fully apparent as this description as this description continues, reference being made to the accompanying drawings and appended claims.

### SUMMARY OF THE INVENTION

The present invention provides new pump technology which advances the state of the art in pump design and efficiency for marginal well pumping applications in the oil and gas industry.

However, this advanced technology can be utilized in almost every major industry involving any form or aspect of pumping liquids and/or semi-liquids.

The present invention, in part, comprises a pump of positive displacement gas-operation having a chamber (which can be constructed of different materials depending upon the type of liquids to be pumped) adapted to be submerged in the middle and/or below the level of fluid to be pumped; a non-return inlet valve (alternatively referred to herein as a flap valve) in the lower part of said chamber communicating with exterior thereof and arranged to allow fluid to enter or pass through into said chamber, but preventing the fluid from exiting or passing out of said chamber; and a non-return outlet valve communicating between the upper part of said chamber and a fluid supply outlet pipe (extending substantially the entire length of the main chamber), said outlet valve being arranged to allow fluid to pass throughout said chamber into said fluid supply outlet pipe (sometimes referred to herein as a discharge pipe and/or tube string and/or pump production string), but preventing the reverse flow of fluid (via means of a check value) back into the main chamber; an inlet pipe positioned at the upper part of said chamber to (a) supply compressed gas into said chamber when the chamber is filled to capacity with the desired fluid, and (b) vent gas from said chamber when said chamber is being filled with the desired fluid; a control valve (controller) and timing device located on the earth's surface and which permits the pressure and exhaust cycles to be predetermined and set according to rate of desired fluid to be removed from the chamber; the chamber is basically configured in a cylindrical form having a vertical axis with said gas inlet/outlet pipe located at upper end of the cylinder; the timing and control devices (having predetermined pressure and exhaust cycles) are connected to a quick exhaust valve at the surface so that during pressure cycling by control of said timing device, it permits pressure in said chamber to quickly exhaust gas from said chamber (during the preset exhaust cycle by the timing device) through the quick exhaust valve.

The outlet valve is located at lower end of the fluid outlet pipe which extends downwardly into said chamber from the upper end of said chamber. A non-return inlet valve, as previously mentioned, comprises a flap valve (the only moving part in the present invention pump) positioned near the bottom of said chamber and moves on a vertical axis in an upward and downward motion depending upon the level of the desired fluid in the chamber. This flap valve slides up and down on an axis member, such as a bolt, which is attached to the bottom of the main chamber.

In a further aspect the present invention, there comprises a pumping system adapted to pump fluid from a well, said pumping system comprising a fluid pump as described in the preceding paragraphs located in said well (positioned in the middle of the desired fluid/oil pad), a gas compressor connected to the gas inlet valve by an gas supply conduit, and a fluid supply conduit connected to said fluid supply outlet pipe. The fluid supply conduit is connected between said fluid supply outlet pipe and a storage tank or transfer line located at the surface. In general, the gas supply conduit and said fluid supply conduits extend down said well to said fluid pump apparatus, generally the upper most portion of the pump chamber.

In a preferred form of the invention, the fluid pump apparatus is constructed with the pump comprising a chamber which is preferably formed to the configuration of a vertical extending and/or elongated cylinder and may conveniently be formed from a length of pipe (made of metal, plastic, polyvinyl chloride (pvc), fiberglass or other suitable materials) having both upper and lower closed ends.

The lower end of the chamber is provided with a non-return inlet valve which is preferably a flap valve having a flap hinged about a vertical axis member to open and close on the openings or holes in the lower end cover of the chamber. However, other suitable inlet valves can be used from an assortment of materials. The inlet/flap valve communicates with the exterior of the chamber allowing fluid to pass through the openings/holes in the end cover/cap into the chamber but preventing fluid from passing through the flap valve from the chamber in the reverse direction.

One of the main advantages of the present invention pump apparatus is the very effective use in shallow wells (such as a depth from 40 feet to 1000 feet). These type wells are not on primary production locations, but are deemed as low producers, for example, producing a few gallons of fluid (like oil) per day to 4 or 5 barrels of fluid (like oil) per day. In the initial operation, it is the object to establish the static fluid level of the well. The pump apparatus is then lowered down the bore into the oil and water areas. The well is pumped down to a point until water is recovered, then measured for gallon amounts. The well is shut-in for 24 hours and then the static fluid level is taken again and compared with the day before. Again, the well is pumped down to the water level and shut down. The process is repeated until it is determined how much oil the well will produce daily without significant water content and the fluid level returns to the static level. A solenoid valve controller, for gas injection is then set to allow pumping to begin and extend for a period of time during which only the desired fluid/oil pad is removed from the well. The gas exhaust time can range from a few minutes to an hour with the pressure cycle ranging from a few seconds to 30 seconds, or more. The pressure is set at the well head controller with the use of an adjustable pressure regulator. Regulating the gas pressure at each well is important because the pump apparatus in each well is set at different levels and a different diameter size pump apparatus is used depending upon the different gravities of the desired fluid. One significant feature of the present invention relates to the fact that only one gas compressor can be used to operate numerous wells such as from 4 wells to 50 wells. One compressor (as shown in FIG. 5) can be utilized to provide a trunk line to each of these wells at a set pressure (in general, pressures are higher then what is needed to effectively make use of the pump apparatus) so at the controller, a regulator is attached to adjust and regulate the desired pressure to each pump apparatus. Then the timer is set for the pumping cycles for each of the individual wells. In the event air or gas get into the production line going to the tank facility, it can be viewed at the wash tank from the vent at the top of the tank or a gas vent can be installed in the production line to reduce air or gas to the facilities (fisher gas vent). Furthermore, the individual wells can be regulated for pressure, cycles on exhaust, and pressure so that air/gas does not exit the pump apparatus.

As previously mentioned, the significance and importance of this unique air/gas pumping system in this industry is to reduce water production and maximize oil recovery, with significantly reduced capital investment. This is accomplished, as described herein, by only skimming the fluid/oil pad off each well produced. This significantly reduces disposal problems with produced water and permits the continued oil production during adverse weather conditions, such as during winter months, with the greatly reduced production of undesirable water and the inherent disposal problems associated therewith.

### DESCRIPTION OF THE DRAWINGS

FIG. 1 sets forth a first sectional view of an embodiment of the pumping system in accordance with an aspect of the present invention and shows the first stage of a pumping cycle wherein the desired material and water are being collected in the pump chamber and discharged to the surface.

FIG. 2 sets forth a second sectional view of an embodiment of the pumping system in accordance with second stage of the present invention being engaged wherein the pump is now positioned in the oil layer/pad and the gas is introduced into the top of the pump chamber. The flap valve closes over the bottom holes and the pumping cycle begins wherein only the desired material/oil is being removed from said pump collection chamber.

FIG. 2A shows the pump in a pressure operation mode with air being forced into the pump chamber and the desired fluid exiting through the production pipe/string. The flap valve is thus in a downward position and closing the holes in the bottom cover of the chamber.

FIG. 2B is a cross sectional view of the bottom cover showing the location of the holes therein and the bolt in the middle thereof and which permits the flap valve to move upward and downward depending upon the chamber pressure.

FIG. 2C discloses the pump in a venting mode wherein the air pressure is reduced and the outside fluid pressure is greater than the pressure inside the pump chamber and thus permits the flap valve to move upward and the fluid to enter the chamber from the well bore.

FIG. 2D is another view of the pump in an operational pressure mode wherein the flap valve is in the downward position thus covering the holes in the bottom cover and the desired fluid is being discharged through the production pile/line.

FIG. 2E is another view of the pump in an operational vent mode or cycle wherein the pressure in the pump chamber is less than the pressure in the wellbore, and the flap valve has moved into an upward position, thus allowing fluid to enter through the holes in the bottom cover of the pump chamber.

FIG. 3 sets forth another embodiment of the invention wherein there is a precursor chemical treatment system showing a conduit (adjacent togas input/discharge pipe) whereby chemicals are injected into the wellbore liquids in order to remove scale, paraffins, wax, scale build up and the like which may have plugged the lower wellbore and casing holes. This conduit may also be initially used to ascertain the initial static liquid level in the wellbore or casing.

FIG. 4 sets forth still another embodiment on the invention wherein a catalytic fluid conditioner device is located on the lower end of the production string or discharge pipe and is used to assist in treating the fluids entering the pump chamber to enhance the flow of the liquids containing any solids therein to flow more easily through the discharge pipe.

FIG. 4A sets forth a typical catalytic fluid conditioner device.

FIG. 5 sets forth another embodiment of the present invention wherein a single air compressor on the surface is positioned to operate with a series of pressure regulators, controllers/timing devices, equipped with quick exhaust valves, to service a number of pumping chambers.

FIG. 5 A sets forth another embodiment of the present invention wherein two or more pumps can be vertically aligned in series to facilitate the oil recovery from deep wells.

### DETAILED DESCRIPTION OF THE INVENTION

The present invention comprises advancement in the state of the art in pumping systems for removing liquids, like hydrocarbons/oil, from subterranean locations and more specifically provides a positive displacement gas operated fluid pump 1 and pumping system described below.

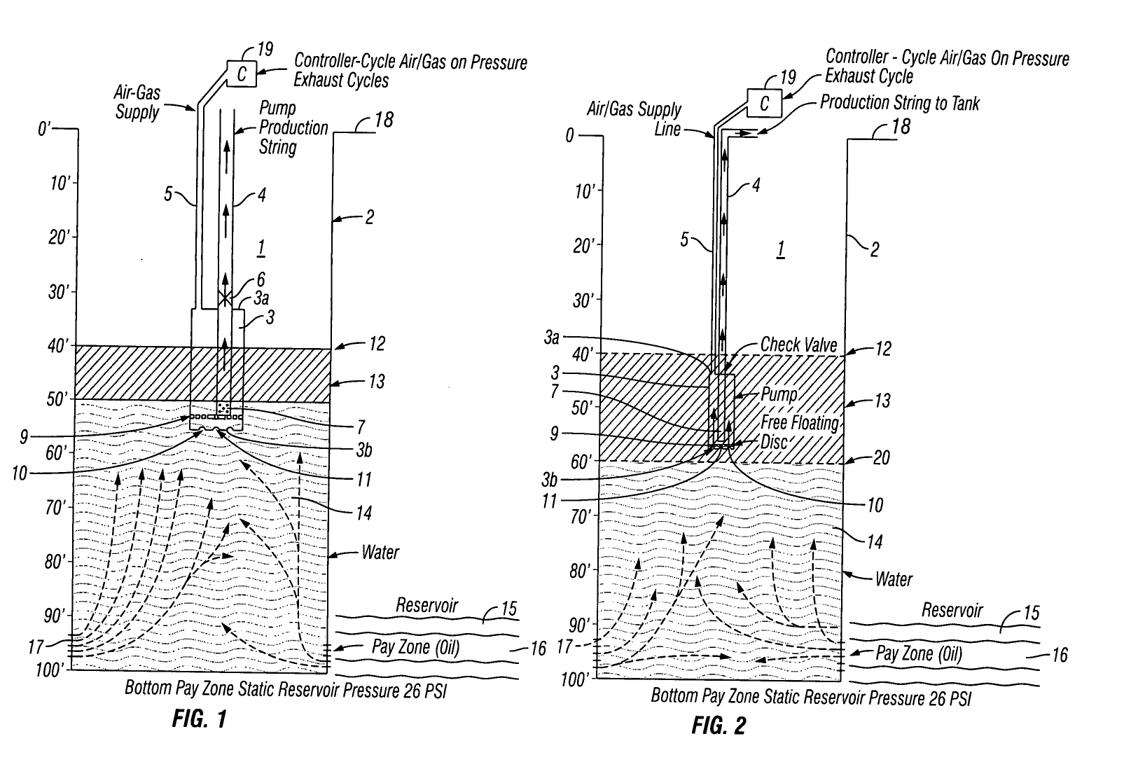

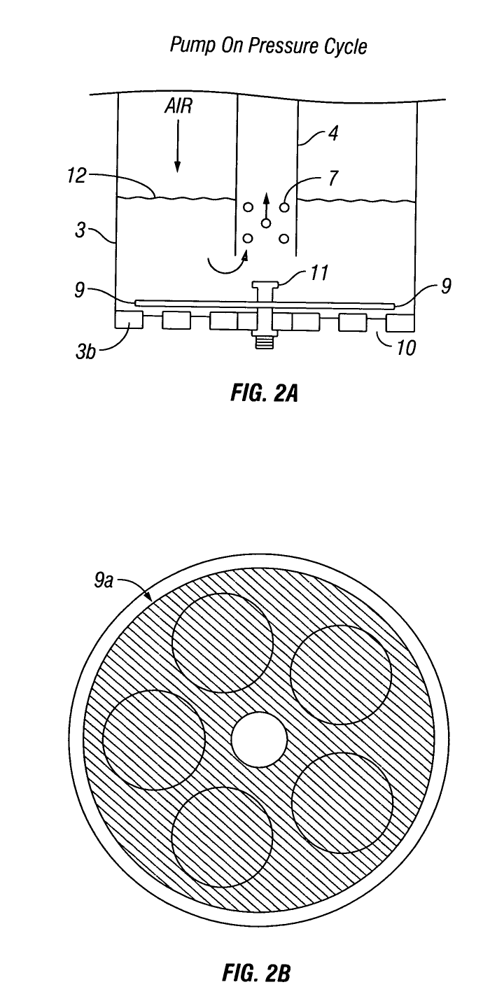

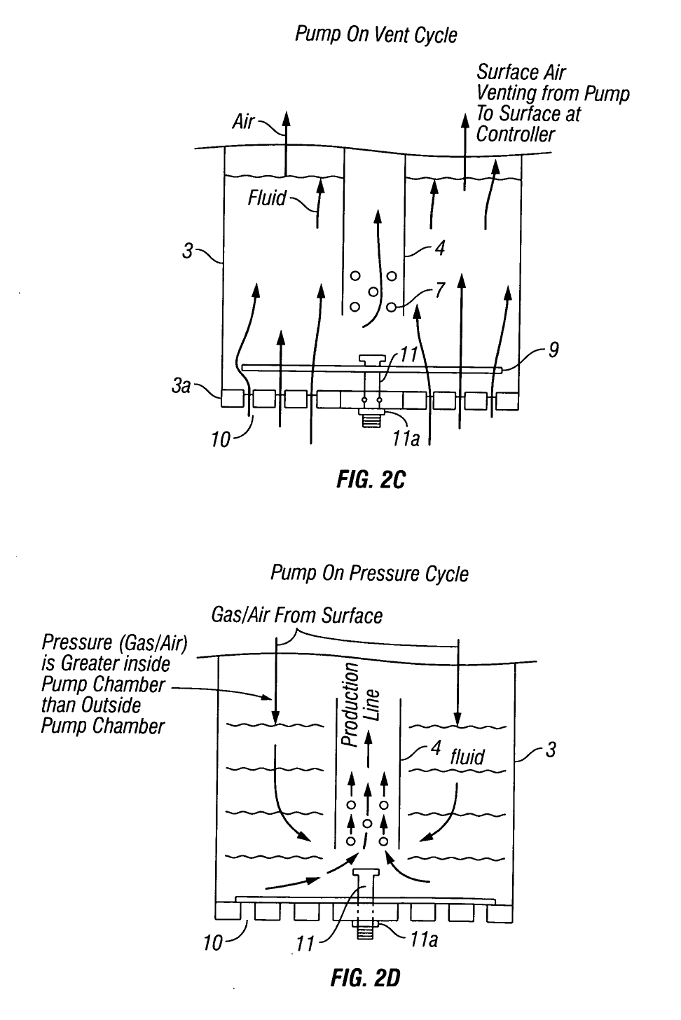

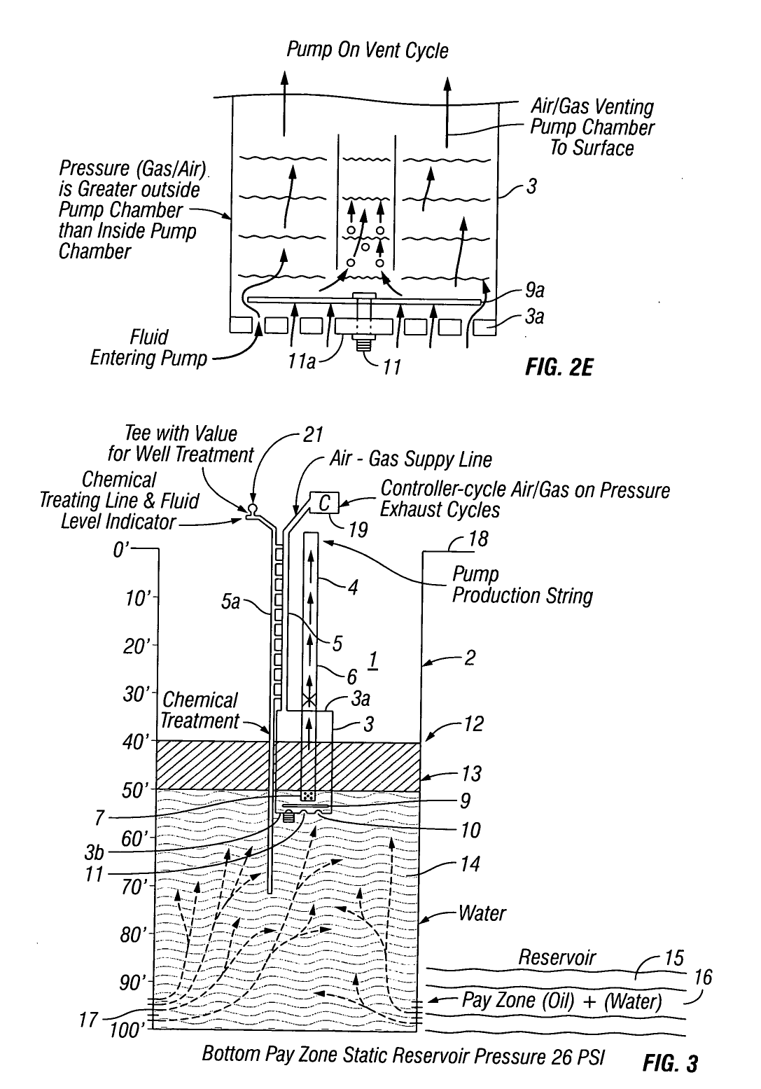

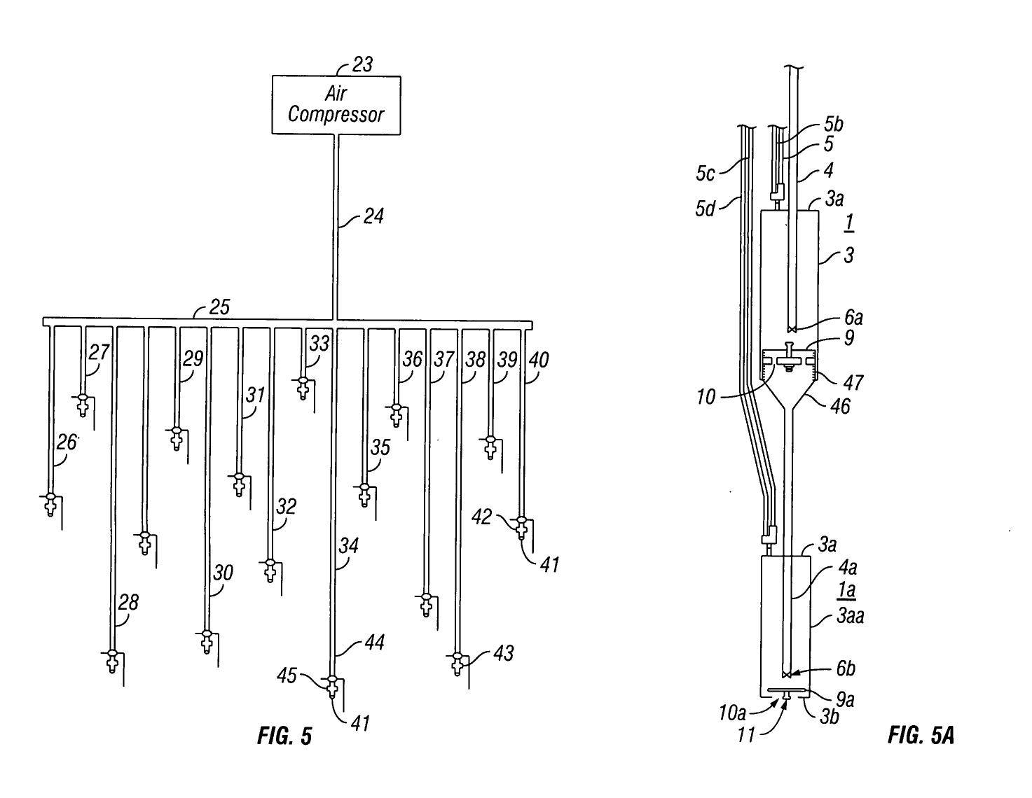

Referring to FIGS. 1 through 5A, pump 1 having chamber 3 is adapted to be lowered in casing 2 and submerged below the level of fluid 12 to be pumped; a flap valve 9 in the lower part of the chamber 3 communicating with exterior wellbore (casing 2) and arranged to allow fluid to pass through holes 10 into the chamber 3 but preventing fluid from passing out of the chamber; the flap valve 9 (acting like a free floating disc) is positioned in the lower part of the chamber and below the fluid supply outlet 4. The flap valve 9 is in a downward position when the chamber is substantially full and covers holes 10. The gas is injected through line/conduit 5 into chamber 3 and the fluid exits chamber 3 into the fluid supply outlet line 4 through perforations 7. The outlet pipe/production string 4 can be either closed or open at the lower most portion thereof. FIG. 2A shows pipe 4 with an open end; however, it can be provided with a end cover (not shown) whereby the flap valve 9 could be attached to this closed end as an alternative to the flap valve attached to the bottom cover 3b of chamber 3. As mentioned, the reverse flow of fluid back into chamber 3 is prevented by check valve 6 which is located just above the pump chamber in line/pipe 4. There can be one or more inlets 5 at the upper part of the chamber 3 to supply compressed gas into the chamber 3 and/or to vent gas from the chamber with the controller/timing device 19 located at the surface 18, thus allowing quick pressure exhaust (FIG. 5) from chamber 3.

Preferably the chamber 3 is comprised of a cylindrical chamber having vertical axis with the check valve 6 located at the upper end of the cylinder 3, with a timing/controller device 19 located at the surface 18 that controls the pressure/exhaust cycles to chamber 3. A quick exhaust valve (FIG. 5) can be located at the top of the chamber or at the surface; this quick exhaust valve allows quick exhausting of the gas from the chamber during the pressure cycle and exhaust gas from the chamber during the exhaust cycle.

The (non-return inlet) flap valve 9 is located at the lower end of chamber 3. This provides a means to control the fluid entering chamber 3. The (non-return inlet) valve flap 9 is comprised of a light weight material, moveable on a vertical axis such as a bolt and moving in an upward or downward position, said bolt and flap valve located in the bottom cover of chamber 3. The flap valve is of such construction whereby it will move easily about the vertical axis depending upon the pressure in chamber 3.

In a further aspect, the invention comprises a pumping system adapted to pump fluid located in a well bore casing 2, the pumping system comprising of a fluid pump 1 (as described in any one or more of the preceding paragraphs) located in a well below the static fluid level 12, and a gas compressor (FIG. 5) connected to the gas inlet valve 5 through controller 19 by a gas supply conduit (a smaller conduit), and a fluid supply conduit (a larger conduit line) is connected to the fluid supply outlet pipe 4. The fluid supply conduit is connected between the fluid supply outlet pipe 4 and a storage tank or transfer line located on the surface. The gas supply conduit and the fluid supply conduit lines extend down the well to the fluid pump 1.

In a preferred embodiment of the invention, fluid pump 1 is constructed wherein pump 1 comprises a chamber 3 which is preferably formed in the configuration of a vertical cylinder and may conveniently be formed from a length of pipe (made from steel, plastic, pvc, fiberglass or other suitable materials for its construction) and having a closed upper end 3a and a closed lower end 3b. The lower end of the chamber is provided with a means to control the flow of fluid into chamber 3 by a non-return inlet/flap valve 9, having a space 9a between chamber wall 3 and the edge of flap valve. This flap valve has a flap hinged about a vertically extending bolt 11 (connected to bottom cover 3a by means of nut 11a) to provide means to open and close openings 10 in the lower end of lower end cover 3b in chamber 3. However, other suitable inlet valves can be used from an assortment of materials. The flap valve 9 communicates with the exterior of the chamber allowing fluid to pass through the openings 10 into the chamber but preventing fluid from passing through the valve from the chamber in the reverse direction when the pressure in chamber 3 is sufficient to cause flap valve 9 to move in a downward position to close the openings and thus prevent fluid from flowing into chamber 3 as shown, respectively in FIGS. 2A and 2D. The size of the flap valve is dependent upon the configuration of the openings 10 in cover 3a, and can be as close as ¼ inch between the side of the flap valve and the chamber wall 3.

In another aspect of the present invention, the pump 1 is provided with a separate (compressed) gas inlet and separate gas vent connected to two or more valves in the upper part of chamber 3 and preferably to a separate gas inlet valve and gas outlet valve respectively. In deeper wells, this pressure/exhaust valve is located above the chamber top with two (2) lines 5 and 5a (FIG. 5A), one line for the pressure cycle to the chamber and the other line for the exhaust cycle to the chamber. In shallow wells, this same pressure/exhaust valve is mounted to the controller/timing device located at the surface with only one gas pressure/exhaust line going to the top of the pump chamber 3. The controller/timing device is made up of an electrically driven 3-way solenoid valve and electric timers (FIG. 22) that control the gas/air cycle phases into and exiting from pump chamber 3.

The compressed gas is supplied to chamber 3 through the gas inlet at the top of the chamber. When the pump is submerged into the fluid level/oil pad 13 which is desired to recover/pump, (without pressure on the gas inlet line, exhaust cycle), the fluid pressure outside the chamber causes the inlet valve to open and fill the chamber. On the pressure cycle, compressed gas is then admitted to the chamber through the gas inlet, forcing the fluid level downward in the chamber and causing the flap valve to close and the outlet valve 6 to open. The desired fluid is forced by the gas pressure through pipe 4 to the outlet where it passes up the outlet pipe 4 and flexible conduit to the point of delivery on the surface. Once the fluid level has been forced down in the chamber and out through pipe 4 and the conduit to the surface, the compressed gas cycle is switched (at the surface by the controller/timing device) and the exhaust cycle starts whereby gas is removed from chamber 3. The compressed gas is then released from the chamber through the vent 5 allowing fluid from the well bore to again enter the chamber 3 through flap valve 9 until the fluid level rises in the chamber 3 and the next cycle starts. The fluid in the outlet pipe 4 is prevented from draining back into the chamber by a non-return outlet means such as a check valve 6.

Cycling automatically continues as the controller, timing and solenoid devices have been preset and/or predetermined by the conditions in the well. In the cycle mentioned above (latter embodiment), the gas inlet valve is opened for a set period by the timing and controller devices, thus allowing compressed gas to enter and force the fluid out through the outlet valve 4. Then, at the end of a set period (for example, from 10 seconds to about 1800 seconds), the inlet/check valve 6 closes and the gas outlet valve 5 opens to vent the compressed gas in the chamber 3, thereby allowing the fluid to rise in the chamber 3. In this manner, the cycles are repeated automatically. In this embodiment, the (internal) out flow/production pipe 4 is arranged centrally in chamber 3 and a circular float device (not shown) is provided which acts as an interface between the compressed gas and the fluid in chamber 3. The circular float is freely movable within the chamber and is typically of hollow plastic construction, lighter then the fluid being pumped. In the pumping operation, the circular float acts as a piston under pressure from the compressed gas. However, there is no need for an air tight fit between the float and the chamber wall, as this would limit its free floating action. The free floating disc (on downward movement in chamber) rides on the internal fluid vent pipe 4 and can seat and seal on discs that are located just above the outlet to the fluid vent pipe 4. These lower non-moving discs are seated and sealed to the chamber wall and are ported to allow fluid to enter and exit the chamber above the outlet valve 4. When in the exhaust cycle phase, the fluid enters chamber 3 through the inlet valve, up through the ported discs allowing the floating disc to move with the incoming fluid in the chamber. This sealing of the movable disc with the nonmovable ported disc allows for little, if any, gas to go below the outlet valve and enter fluid vent pipe 4. This design is used in hydrocarbon producing wells where a gas of undesired qualities would be prevented from mixing with the production stream. In fluids other then hydrocarbons, the floating disc and the non-movable discs are not needed.

According to the invention, the fluid pump may be used in a number of different applications for pumping a wide variety of fluids.

The volume of gas in the compressed gas supply line acts through a gas regulator as a compressed gas reservoir to smooth out the gas demand between the intermittent operation of the pump and the continuous supply from the gas compressor. This applies to when the pressure/exhaust valve is mounted at the top of chamber 3 of the pump. If necessary, the amount of compressed gas held in reserve may be increased by providing a pressure tank (in line) with the surface gas compressor.

One of the main advantages of the present invention pump apparatus is the very effective use in shallow wells (depth from 40 feet to 1000 feet). These type wells are not on primary production locations, but are deemed as low producers, for example, producing a few gallons of fluid (like oil) per day to 4 or 5 barrels of fluid (like oil) per day.

In operation, it is generally necessary to establish the static fluid level of the well. The method for measuring well water levels (in this case, the static fluid level of the well) is known in the art; for example, an excellent article on this procedure is set forth in an article entitled “Measuring Well Water Levels”, by W. L. Trimmer, Oregon State University, Extension Service, EC 1368, reprinted in August 2000. Additional information regarding measuring well water/fluid levels may be reviewed at http://www.wrd.state.or.us/OWRD/GW/well-data.shtml.

After the static fluid level is determined, the pump apparatus is lowered down the well bore into the oil/water mixture. The well is pumped for a period of time until water is recovered, then measured for gallon amounts. The well is shut-in for period of time, such as 24 hours, and then the static fluid level is taken and compared with the day before. Again, the well is pumped down to the water level and shut down. The process is repeated until it is determined where the oil pad is located and how much oil the well will produce daily without water (preferably less than 10% water, and more preferably 2% to about 5% water) and the fluid level returns to the static level. The controller/timing system is located at the well head (surface), and air/gas is provided from a central supply system delivered through a supply air/gas trunk line with a pressure regulator located before the controller in order to control the pressure to the pump. This arrangement allows only what is needed to pump at its most effective operating mode. Then there is a Quick Exhaust valve (examples of these devices are shown in U.S. Pat. No. 3,608,581; U.S. Pat. No. 3,680,582; U.S. Pat. No. 5,465,746; and U.S. Pat. No. 7,490,622) on the discharge of the controller in order to reduce the vent time at the surface, allowing the wellbore fluid to enter the pump at the free-flowing disc/flap valve 9, located at the bottom of the pump chamber. The timer on the controller can be adjusted from seconds to hours in both cycles of pressure and exhaust modes. The supply, trunk or production line, can also function as an additional air/gas supply tank. The pressure regulator can be adjusted to meet the pressure demands of the pump to lift the fluid/oil to a surface tank or facility.

The air/gas in the pump is vented back through the air/gas supply line to the Quick Exhaust valve that is attached to the controller's discharge side. The Quick Exhaust valve opens a port to vent the air/gas, and which is larger than the air/gas supply line to the pump. The controller is located at the well head (surface) in order to provide a short distance to the pump from the controller. This arrangement allows a pressure differential between the inside of pump chamber 3 and the fluid outside of the pump chamber wherein it is submerged therein. This arrangement then allows for the fluid to move into the pump chamber through the bottom cover holes, and at this point, the free-floating disc, flap valve 9, is located in an upward position and not covering the holes 10. The pumping and exhaust cycling modes continue.

Each pumping operation, for an individual well, is thus predetermined. Thus, the solenoid valve controller/timer is then set to pump the well down to just remove the desired fluid/oil pad from the well. The exhaust time can range from a few minutes to an hour with the pressure cycle from a few seconds to 30 seconds. The pressure is set at the well head controller with the use of an adjustable pressure regulator. Regulating the pressure at each well is important because the pump apparatus in each well is set at different levels and a different diameter size pump apparatus is used depending upon the different gravities of the desired fluid. One compressor can be used to operate from 4 well to 50 wells; note FIG. 5. One compressor can be utilized to provide a trunk line to each well at a set pressure (in general, pressures are higher then what is needed to effectively make use of the pump apparatus) so at the controller, a regulator is attached to adjust and regulate the desired pressure to each pump apparatus. Then the timer is set for the pumping cycles for each of the individual wells. In the event air or gas gets into the production line going to a holding tank facility, it can be viewed at the wash tank from the vent at the top of the tank or a gas vent can be installed in the production line to reduce air or gas to the facilities (such as a Fisher gas vent). Furthermore, the individual wells can be regulated for pressure, cycles on exhaust, and pressure so that air/gas does not exit the pump apparatus.

As previously mentioned, the significance and importance of this unique air/gas pumping system in this industry is to reduce water production and maximize oil recovery and provide safe environmental conditions. This is accomplished, as described herein, by skimming basically only the fluid/oil pad off each well produced. This significantly reduces disposal problems with produced water and permits the continued oil production during adverse weather conditions, such as during winter months, with the reduction of produced water and the inherent problems associated therewith.

The operations of this unique pumping system is vividly demonstrated in FIGS. 1, 2, 2A-E, 3, 4, and 5.

In another embodiment of the present invention and referring to FIG. 3, there is an additional conduit 5a extending from the surface to below the pump chamber 3 and into the water strata in the bottom portion of the well bore. In general, most oil wells, both flowing and those served by a down hole pump, are plagued with slow flow, clogging and expensive periodic maintenance of the well caused by deposits of paraffins and other waxes carried in most crudes. These paraffins and other waxes tend to deposit on the walls of the casing 2 and holes 17 and when a down hole pump is used, on the pump chamber and even the discharge pipe 4, to slow or even stop the flow of crude to the surface. To restore proper recovery of the crude oil in the past, it was necessary to cease operation and pull the pump for cleaning or resort to frequent expensive “hot oiling”. In this aspect of the present invention, conduit 5a is used to charge a specific chemical composition into the lower portion of the well bore in order to dissolve and/or unplug the clogged holes 17 and thus promote greater flow of the surrounding oil into the well bore through holes 17 in casing 2. In this facet, there is provided a method for cleaning oil wells to increase the flow of oil thereof by use of a unique aqueous cleaning composition comprising water, a hydrocarbon solvent, a detergent and mineral acid. This one step method provides for the simultaneously cleaning/removal of asphaltine and/or paraffin and scale simultaneously from the oil well containing clogged holes, apertures, perforations or openings comprising the steps of (a) preparing an aqueous cleaning composition consisting essentially of i) from about 50% to about 98% by weight, water; ii) from about 0.1% to about 15% by weight, detergent; iii) from about 0.1% to about 20.0% by weight, hydrocarbon solvent; and iv) from about 0.1% to about 15.0% by weight, acid, with the proviso that said composition is in a stable state over a wide range of temperatures; (b) contacting said composition with the interior of the oil well for a period of time sufficient to dispense asphaltenes, paraffins and scale within the well from said openings. In general, the water is conditioned water (this water is conditioned by the use of commercially available devices sold under the trademark names CAREFREE and EASYCARE water conditioners); the detergent contains a material selected from the group consisting of zwitterionic, ampholytic, nonionic, anionic and cationic surfactants and mixtures thereof; the hydrocarbon solvent is selected from the group consisting of gasoline, diesel, jet fuel, kerosene, zylene, mineral spirits and mixtures thereof; and the acid is selected from the group consisting of hydrochloric acid, sulfuric acid, nitric acid, hydrofluoric acid, citric acid, oxalic acid, maleic acid, acetic acid, malic acid, glutaric acid and mixtures thereof. This method and the further description of using these compositions is further described in U.S. Pat. No. 7,296,627 and U.S. Pat. No. 7,670,993.

In another aspect of this embodiment, it has been found that the pH of the well is determinative of whether or not there is a need for the acid to be included in the cleaning composition/fluid. It has been found that if the pH of the well is about 7.2 or less than 7.2, then there is no requirement for the acid to be used as the results (without acid) will be essentially the same if the acid component is used. This embodiment is further described in U.S. Pat. No. 7,497,261 and U.S. Pat. No. 7,632,785.

If it is desired to pump fluid from wells of greater depth, it is possible to provide fluid pumps in series, FIG. 5A, at intervals down the well bore so that the lower pump 3aa raises fluid to the level of the next pump 3 which then raises fluid farther up the well bore through discharge pipe 4 to the surface. The pumps are connected in series (FIG. 5A) with multiple air supply lines (5, 5b, 5c, and 5d) to the different stages of pumps throughout the well with each pump on a cycle controller at the surface regulated by a timing device. The discharge pipe 4a in pump chamber 3aa is connected to the bottom of pump chamber 3 by a threaded cylinder 47 and funnel shaped section 46. The series of pumps operate in the same manner as described with reference to FIGS. 1, 2, and 3. The length of each individual pump can be from about 4 to about 30 feet, but generally is from about 6 to about 10 feet. The diameter of the pump chamber can vary depending upon the well bore/casing diameters, considering spacing for ease in lowering and removing the pumps from the wells. In general, the pump diameter size is about 2 to 6 inches, generally from about 2 to 4 inches.

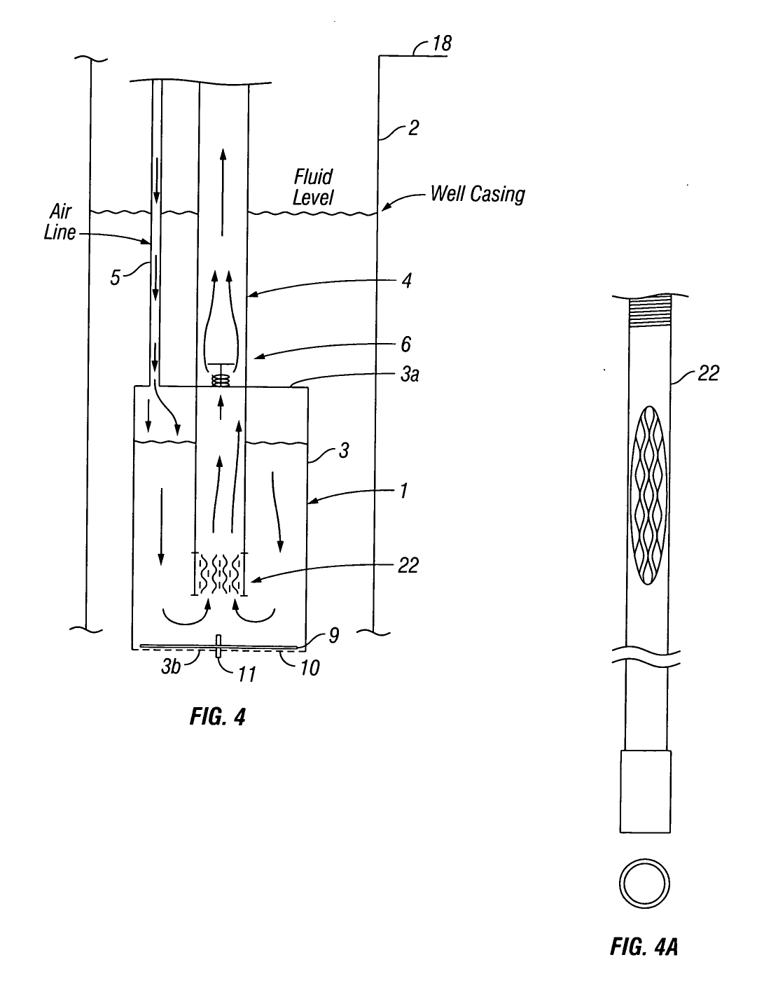

In another aspect of the present invention and referring to FIGS. 4 and 4A, an in-line catalytic fluid conditioner 22 can be used to improve operational results.

Many oil wells, both flowing and those served by a down hole pump, are plagued with slow flow, clogging and expensive periodic maintenance of the well caused by deposits of paraffins and other waxes carried in most crudes. These paraffins and other waxes tend to deposit on the walls of the casing 2 and holes 17 and when a down hole pump is used, on the pump chamber and even the discharge pipe 4 to slow or even stop the flow of crude to the surface. To restore proper recovery of the crude oil in the past, it was necessary to cease operation and pull the pump for cleaning and/or resort to frequent expensive “hot oiling” or chemical treatment of the well. In this facet of the invention, there comprises the use of an in line catalytic fluid conditioner apparatus 22 attached to lower portion of the production tubing string/discharge pipe 4 located in pump chamber 3. For example, the apparatus 22 used can be similar to that shown in U.S. Pat. No. 5,485,883. In this device, it comprises two spaced apart cylindrical metal tubes having a common vertical axis. Both tubes may be made of a pure copper-nickel alloy or preferably, the outer tube is made of a ferrous metal and its inner surface flame coated or electrostaticly plated with pure copper-nickel alloy.

The wall of the innermost tube contains a multiplicity of spaced apart radially bored holes and its upper end is capped. The opposite or lower end of the inner tube is joined to the lower end of the outer tube so that the only entry into the device is through the lower end of the inner tube and the only exit from the device is the upper or exit end of the outer tube which, in the present invention, is connected to discharge pipe 4 which extends in pump chamber 3. The elongated annular chamber between the inner and outer tubes bounded by copper-nickel surfaces becomes an electron exchange chamber when crude oil under pressure is fed into the chamber, as described herein before with reference to FIGS. 1, 2, and 3. As mentioned, the upper end of its outer tube is threaded so that apparatus 22 can be screwed onto the lower end of the tubing string/discharge pipe 4.

When the pump is operating, crude oil enters through the open lower end of the apparatus 22 inner tube by pressure into the inner tube causing a multiplicity of streams or jets of crude oil to issue from the radially bored holes in the wall of the inner tube to bombard the copper-nickel walls of the annular chamber between the two tubes. Electrons freed from the copper in the walls of the chamber combine with molecules of the crude oil itself as well as with molecules of the paraffins and other ingredients entrained in the crude oil, thereby altering certain physical characteristics of the crude oil and produced water, if any, and of the other entrained ingredients.

The crude oil and its entrained ingredients treated in this type of apparatus, as above described, passes through the string of tubing 4 to the surface. The treated crude oil not only is free of paraffins and other waxes which tend to clog the casing 2, pump chamber 3 and tubing 4, also the apparatus 22 breaks up the long chain hydrocarbon molecules, making the oil “slicker” and less capable of transporting suspended solids. On high paraffin, low gravity crudes, the treatment increases the American Petroleum Institute specific gravity of the resulting crude by at least two or three points thus increasing the marketability of these types of treated crude oil. A type of conditioner that is used with the present invention is shown in FIG. 4A along with specifications. Other type conditioners, for example, that can be used in this aspect of the present invention, are described in U.S. Pat. No. 6,989,095 and U.S. Pat. No. 7,481,922.

All of the prior art references cited herein are to be considered as incorporated herein by reference in their entirety.

### Examples 1-29

While FIGS. 1 through 5 are drawings/schematics showing the ultra pumping system, the ultra pumping system per se was tested in an oil field in Crook County, Wyo., and are submitted as Examples 1-29. In general, these figures have been briefly described above in conjunction with the general description of the drawings. The diameter size of the pump chamber and the length thereof was predetermined in order to test different sizes and lengths in wells of different depths. The pump chamber diameter size, length and the well depth are shown in Table 1. The air pipe and production string/pipes at the top of the pump chamber were, respectively, connected to flexible poly tubing, and then these were positioned just outside the top cover of the pump chamber. The overall chamber (with the connected poly tubing), was then the lowered into the well and well within the static fluid level (Table 1) which had been measured earlier based upon a “plum-bob” measurement. The initial operation of the pump was started in order to ascertain the fluid content of the material removed. In most cases, it took 40 minutes to pump remove the desired fluid. The average pump down resulted in a fluid content wherein the oil was about 98% by weight of the material being removed. The pressure regulator, controller and timer were set at each well for the pumping and venting modes/cycling shown in Table 1. These wells were each tested for several days and the end result was a consistent production of 1 to 3 barrels of oil per day with a maximum of only 1-3% by weight water content. The above tests utilizing this ultra pumping system demonstrates the uniqueness of the invention.

TABLE 1

| | | | | Air Controller | |
|---|---|---|---|---|---|
| | | Depth of Static | | Settings | |
| No. | Well ID | Fluid Level-Ft. | PUMP Depth-Ft. | Off-Sec. | On-Sec. |
| 1 | 16D | 160 | 160 | 300 | 30 |
| 2 | 3 | 96 | 150 | 120 | 30 |
| 3 | 2 | 60 | 150 | 10 | 10 |
| 4 | 1 | 96 | 150 | 10 | 10 |
| 5 | D4 | 40 | 150 | 10 | 10 |
| 6 | U4 | 70 | 150 | 10 | 10 |
| 7 | 1E | 60 | 150 | 10 | 10 |
| 8 | 1-D | 96 | 200 | 10 | 10 |
| 9 | 3-D | 66 | 150 | 10 | 10 |
| 10 | 25 | 66 | 150 | 180 | 25 |
| 11 | 33 | 240 | 380 | 10 | 10 |
| 12 | 1 | 180 | 280 | 300 | 30 |
| 13 | 1.1 | 2-66 | 15-80 | 1800-300 | 30-10 |
| 14 | 1.2 | 2-66 | 15-80 | 1800-300 | 30-10 |
| 15 | 1.3 | 2-66 | 15-80 | 1800-300 | 30-10 |
| 16 | 1.4 | 2-66 | 15-80 | 1800-300 | 30-10 |
| 17 | 1.5 | 2-66 | 15-80 | 1800-300 | 30-10 |
| 18 | 1.6 | 2-66 | 15-80 | 1800-300 | 30-10 |
| 19 | 1.7 | 2-66 | 15-80 | 1800-300 | 30-10 |
| 20 | 1.8 | 2-66 | 15-80 | 1800-300 | 30-10 |
| 21 | 1.9 | 2-66 | 15-80 | 1800-300 | 30-10 |
| 22 | 2.1 | 2-66 | 15-80 | 1800-300 | 30-10 |
| 23 | 2.2 | 2-66 | 15-80 | 1800-300 | 30-10 |
| 24 | 2.3 | 2-66 | 15-80 | 1800-300 | 30-10 |
| 25 | 2.4 | 2-66 | 15-80 | 1800-300 | 30-10 |
| 26 | 2.5 | 2-66 | 15-80 | 1800-300 | 30-10 |
| 27 | 2.6 | 2-66 | 15-80 | 1800-300 | 30-10 |
| 28 | 2.7 | 2-66 | 15-80 | 1800-300 | 30-10 |
| 29 | 3.1 | 2-66 | 15-80 | 1800-300 | 30-10 |

In conjunction with Table 1 above, Examples 1-9 were conducted in the Windcreek field area of Crook County, Wyo.; Examples 10 and 11 were in the Hadley field area; Example 12 was in the New Castle, J. Carr, field area; and Examples 13-29 were in the Arch Creek field area. In Examples 1, 2, 5-9, and 10-21, there was used a 2 inch diameter pump; Examples 3, 4, 10, and 22-28 used a 3 inch diameter pump; and in Example 29, the pump diameter size was 4 inches. In Examples 1, 2, and 29, the pump length was 6 feet; in Examples 3, 4, and 22-28, the pump length was 8 feet; and in Examples 5-21, the pump length was 10 feet. Regarding the Production Facility utilized, Examples 1, 2, 10 and 12-29 had a Tank Battery; Examples 3-9 and 11 utilized a Portable Tank.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. A pump for removing liquids from a well comprising:
an elongated cylindrical pump chamber having a first cover on the top end of said chamber and a second cover on the bottom of said chamber, said pump chamber arranged to receive liquid to be pumped and gas to enter and exit there from;
means to supply gas under pressure to the pump chamber, said gas entering said chamber through a first pipe connected to the first cover and protruding there through in an opening therein;
an elongated cylindrical second pipe having a diameter smaller than the said elongated cylindrical pump chamber, and arranged within said pump chamber and substantially the length of said pump chamber, said second pipe extending from the bottom portion of said pump chamber through the first cover on the top of said pump chamber and extending upward beyond the first cover and said upper portion of the second pipe having a valve means to control the flow of the liquid to be pumped there through to a ground level source;
a non-return inlet first valve connected to the bottom portion of said pump chamber and arranged to be moved on a vertical axis in an upward or downward manner depending upon the gas pressure in the pump chamber;
holes located in the bottom portion of said pump chamber whereby liquid enters into said pump chamber when the pressure therein is less than the outside liquid pressure and the first valve is in an upward mode and does not cover these holes in the bottom portion of said pump chamber, and gas in said pump chamber exits through said first pipe; and
perforations located around the bottom portion of said second pipe whereby liquid enters said second pipe when the pressure in the pump chamber is greater than the outside liquid pressure and the first valve is in a downward mode and covers the holes in the bottom portion of the pump chamber, said liquid then exiting the pump chamber through the second pipe.

2. A pump system for removing liquids from a well comprising:
an elongated cylindrical pump chamber having a first cover on the top end of said chamber and a second cover on the bottom of said chamber, said pump chamber arranged to receive liquid to be pumped and gas to enter and exit there from;
means to supply gas under pressure to the pump chamber, said gas entering said chamber through a first pipe connected to the first cover and protruding there through in an opening therein;
an elongated cylindrical second pipe having a diameter smaller than the said elongated cylindrical pump chamber, and arranged within said pump chamber and substantially the length of said pump chamber, said second pipe extending from the bottom portion of said pump chamber through the first cover on the top of said pump chamber and extending upward beyond the first cover and said upper portion of the second pipe having a valve means to control the flow of the liquid to be pumped there through to a ground level source;
a non-return inlet first valve connected to the bottom portion of said second cover of the pump chamber and arranged to be moved on a vertical axis in an upward or downward manner depending upon the gas pressure in the pump chamber;
holes located in the bottom portion of said pump chamber whereby liquid enters into said pump chamber when the pressure therein is less than the outside liquid pressure and the first valve is in an upward mode and does not cover these holes in the bottom portion of said pump chamber, and gas in said pump chamber exits through said first pipe;
perforations located around the bottom portion of said second pipe whereby liquid enters said second pipe when the pressure in the pump chamber is greater than the outside liquid pressure and the first valve is in a downward mode and covers the holes in the bottom portion of the pump chamber, said liquid then exiting the pump chamber through the second pipe;
means to convey the liquid from the top portion of said second pipe to a ground level source; and
a timer, controller and valve means arranged to achieve a set time for controlling the pumping apparatus to cycle in a pumping liquid mode and gas exhaust mode in order to recover oil from the pump chamber in the wellbore casing and supplying or removing gas from said pump chamber, whereby said oil contains less than about ten percent by weight water.

3. The apparatus as set forth in claim 2 wherein there is provided means to screen out material which could inhibit the functioning of the pumping apparatus, said means comprising a cylindrical member detachably attached to the bottom portion of said pump chamber and having apertures arranged around the perimeter thereof in order to perform this screening function.

4. The apparatus as set forth in claim 2 wherein two or more pump apparatuses are aligned in series to facilitate the removal of oil from deep wells.

5. The apparatus as set forth in claim 2 wherein said bottom portion of said second pipe is provided with an in line catalytic fluid conditioner which enhances the fluid flow of the oil through the second pipe to the ground surface.

6. The apparatus as set forth in claim 2 wherein the pump chamber is from about 2 inches to about 6 inches in diameter and the pump chamber is from about 4 to about 30 feet in length.

7. A method of removing oil from an underground location comprising the steps:
(A) lowering a pump apparatus down a wellbore casing to a point where said pump is positioned in at least a portion of the liquid, comprising oil and water, located in said casing, said pump comprising:
an elongated cylindrical pump chamber having a first cover on the top end of said chamber and a second cover on the bottom of said chamber, said pump chamber arranged to receive liquid to be pumped and gas to enter and exit there from;
means to supply gas under pressure to the pump chamber, said gas entering said chamber through a first pipe connected to the first cover and protruding there through in an opening therein;
an elongated cylindrical second pipe having a diameter smaller than the said elongated cylindrical pump chamber, and arranged within said pump chamber and substantially the length of said pump chamber, said second pipe extending from the bottom portion of said pump chamber through the first cover on the top of said pump chamber and extending upward beyond the first cover and said upper portion of the second pipe having a valve means to control the flow of the liquid to be pumped there through to an upper ground level source;
a non-return inlet first valve connected to the bottom portion of said second cover of the pump chamber and arranged to be moved on a vertical axis in an upward or downward manner within said pump chamber depending upon the gas pressure in the pump chamber;
holes located in the bottom cover of said pump chamber whereby liquid enters said pump chamber when the pressure therein is less than the outside liquid pressure and the first valve is in an upward mode and does not cover these holes in the bottom cover of said chamber, and gas in said pump chamber exits through said first pipe; and
perforations located around the bottom portion of said second pipe whereby liquid enters said second pipe when the pressure in the pump chamber is greater than the outside liquid pressure and the first valve is in a downward mode and covers the holes in the bottom cover of the pump chamber, said liquid then exiting the pump chamber through the second pipe;
(B) pumping down the fluid level to a point where substantially only oil is being pumped through the second pipe and is recovered at the surface ground level from a conduit connected to the top portion of said second pipe;
(C) continuing pumping the oil using the pumping apparatus until the oil is reduced to a very minor flow and gas is the major material exiting the second pipe;
(D) discontinuing the pumping operations for a period of time in order to achieve a predetermined static fluid level in the well casing;
(E) providing a timer, controller and valve means to achieve a set time for controlling the pumping apparatus to cycle in a pumping liquid mode and gas exhaust mode in order to recover oil from the wellbore casing and supplying or removing gas from said pump chamber, whereby said oil contains less than about ten percent by weight water.

8. The process as set forth in claim 7 wherein the pressure generated in the pumping apparatus to promote the flow of oil to the surface is from about 15 to about 40 psig.

9. The process as set forth in claim 8 wherein the pressure in the conduit above the upper portion of the second pipe is sufficient to close the valve means in the upper portion of said second pipe and prevent any fluid from exiting the pumping chamber, and thus permits fluid to enter the pumping chamber through the holes in the bottom portion of said pump chamber.

10. The process as set forth in claim 9 wherein the oil exiting from the pumping chamber through said second pipe contains from about 2 percent to about 5 percent by weight water.

11. The process as set forth in claim 10 wherein said bottom portion of said second pipe is provided with an in line catalytic fluid conditioner which enhances the fluid flow of the oil through the second pipe to the ground surface.

12. The process as set forth in claim 11 wherein there is provided means to measure the static fluid level in the well bore casing before the pumping apparatus is lowered into the well bore.

13. The process as set forth in claim 12 wherein before the static fluid level is measured, there is provided means to supply a cleaning composition to the lower portion of said well bore in order to facilitate the unplugging of any of the perforations located in the casing wall.

14. The process as set forth in claim 13 wherein the cleaning composition comprises
i) from about 50% to about 98% by weight, water;
ii) from about 0.1% to about 15% by weight, detergent;
iii) from about 0.1% to about 20.0% by weight, hydrocarbon solvent; and, optionally
iv) from about 0.1% to about 15.0% by weight acid.
